(19) United States
(12) Patent Application Publication
(10) Pub. No.: US 2013/0006880 A1
(43) Pub. Date: Jan. 3, 2013

(54) METHOD FOR FINDING ACTIONABLE COMMUNITIES WITHIN SOCIAL NETWORKS

(75) Inventors: Kuntal Dey, Vasant Kunj (IN); Ritesh Gupta, Vasant Kunj (IN); Natwar Modani, Gurgaon (IN); Seema Nagar, HauzKhas (IN); Amit A. Nanavati, Vasant Kunj (IN)

(73) Assignee: International Business Machines Corporation, Armonk, NY (US)

(21) Appl. No.: 13/171,594

(22) Filed: Jun. 29, 2011

(51) Int. Cl. G06Q 99/00

(52) U.S. Cl. 705/319

(57) ABSTRACT

A non-transitory computer storage medium stores a method that includes identifying a social network of a plurality of entities, each entity being associated with at least one other entity in the social network. A group of entities is identified from the plurality of entities that have expressed an interest in any one of a plurality of items. A primitive-community for each of the groups of entities is determined for each distinct item of the plurality of items. Common sets of entities are determined within each primitive-community associated with the each distinct item of the plurality of items based on a minimum support level, using a frequent itemset mining approach, where the first primitive community and the second primitive community are treated as transactions and entities are treated as items.

### BACKGROUND

The embodiments herein generally relate to finding actionable communities within a social network, more particularly, to finding communities based on (a) the number of primitive communities a group of entities belong to, and (b) the number of products that the group of entities has purchased together. Cliques, dense groups, k-plexes are examples of primitive communities.

Finding communities in social networks is a well-studied topic. A community in social network is commonly being defined as a group of people whose interactions within the group are more than outside the group. It is believed that people's behavior can be linked to the behavior of their social neighborhood. However, it is not demonstrated that social communities are like-minded, i.e., they behave similarly in terms of their interest in items (e.g., movies, products, services).

Thus, there remains a need to find actionable communities within a social network based on (a) the number of primitive communities a group of entities belong to, and (b) the number of products that the group of entities has purchased together.

### SUMMARY

According to one embodiment, computer-implemented method that includes identifying a social network of a plurality of entities, where each entity is associated with at least one other entity in the social network. A first group of entities is identified from the plurality of entities that have expressed an interest in a first item. At least one first primitive community is identified from the first group of entities. An example of primitive community is clique which is being defined as a sub-group of the group of entities where all possible pairs of entities have an association between themselves. A second group of entities is identified from the plurality of entities that have expressed an interest in a second item. At least one second primitive community is identified from the second group of entities. Common sets of entities are identified within the at least one first primitive community of the first group and the at least one second primitive community of the second group based on a minimum support level, using a frequent itemset mining approach, where the primitive communities are treated as transactions and entities are treated as items. A union including all distinct entities is determined from the common sets of entities, and at least one community of entities is determined from the social network plurality of entities based on the union of all entities applied to the social network.

According to another embodiment, a computer-implemented method that includes identifying a social network of a plurality of entities, each entity being associated with at least one other entity in the social network. A first group of entities is identified from the plurality of entities that have purchased a first item, and at least one first primitive community is identified from the first group of entities. A second group of entities is identified from the plurality of entities that have purchased a second item, and at least one second primitive community is identified form the second group of entities. Common sets of entities are determined within the at least one first primitive community of the first group and the at least one second primitive community of the second group based on a minimum support level, using a frequent itemset mining approach, where the primitive communities are treated as transactions and entities are treated as items. A union including all distinct entities is determined from the common sets of entities, and at least one community of entities is determined from the social network plurality of entities based on the union of all entities applied to the social network.

According to another embodiment, a computer-implemented method that includes identifying a social network of a plurality of entities, each entity being associated with at least one other entity in the social network. A group of entities is identified from the plurality of entities that have expressed an interest in any one of a plurality of items. A primitive community for each of the groups of entities is determined for each distinct item of the plurality of items. Common sets of entities are determined within each primitive community associated with each distinct item of the plurality of items based on a minimum support level, using a frequent itemset mining approach, where the primitive communities are treated as transactions and entities are treated as items. A union including all distinct entities is determined from the common sets of entities, and at least one community of entities is determined from the social network plurality of entities based on the union of all entities applied to the social network.

According to another embodiment, a non-transitory computer storage medium readable by a computer tangibly embodying a program of instructions executable by the computer for performing a method that includes identifying a social network of a plurality of entities, each entity being associated with at least one other entity in the social network. A first group of entities is identified from the plurality of entities that have expressed an interest in a first item. At least one first primitive community is identified from the first group of entities. A second group of entities is identified from the plurality of entities that have expressed an interest in a second item. At least one second primitive community is identified from the second group of entities. Common sets of entities are identified within the at least one first primitive community of the first group and the at least one second primitive community of the second group based on a minimum support level, using a frequent itemset mining approach, where the primitive communities are treated as transactions and entities are treated as items. A union including all distinct entities is determined from the common sets of entities, and at least one community of entities is determined from the social network plurality of entities based on the union of all entities applied to the social network.

### BRIEF DESCRIPTION OF THE SEVERAL VIEWS OF THE DRAWINGS

FIG. 1 illustrates a table of product purchase data or an expressed interest in an item;

FIG. 2 illustrates an underlying social network of all customers;

FIG. 3 illustrates an embodiment of a subgraph of product P1 for customers C1-C10;

FIG. 4 illustrates an embodiment of a subgraph of product P2 for customers C1-C10;

FIG. 5 illustrates an embodiment of a subgraph of product P3 for customers C1-C10;

FIG. 6 illustrates an embodiment of a subgraph of product P4 for customers C1-C10;

FIG. 7 illustrates a diagram for determining communities that meet a minimum support value using frequent itemset;

FIG. 8 illustrates an embodiment of a subgraph of a union of communities output from a function of determining a minimum support value or FIG. 7;

FIG. 9 illustrates an embodiment of the subgraph of FIG. 8 having a grow back feature to include a customer not normally associated within a defined community;

FIG. 10 illustrates a logic flowchart of one embodiment;

FIG. 11 illustrates another logic flowchart of another embodiment; and

FIG. 12 illustrates a computer system used to implement an embodiment.

### DETAILED DESCRIPTION

People who are commonly interested in a particular item are socially well connected. Motivated by this fact, an embodiment includes a method for finding communities wherein like-mindedness is an explicit objective. Finding small tight groups with many shared interests is accomplished by first finding primitive communities, then using a frequent itemset mining approach and using these frequent itemsets as building blocks to determine core memberships of like-minded (“actionable”) communities. The actionable communities can be extended by adding suitable members to the cores. These like-minding communities have higher similarity in their interests compared to (primitive) communities found using only the interaction information. These communities can be utilized for viral marketing since the participants are both like-minded as well as socially well-connected.

Forming communities is one of the fundamental traits of people in social networks. Many methods have been proposed and investigated for finding communities in social networks. These communities are based on the communication patterns in the social networks. A community in social network is defined as a group of people whose interactions within the group are more than outside the group. Communities have often been linked to common characteristics of the community members. In fact, quite often, the presence of a common characteristic among members of a community is taken as an indicator of good quality of the communities found. For example, the well known Zachary's karate-club and NCAA college football dataset are used as test of quality of the community finding algorithms, where the membership of the faction/conference is taken as the ground truth.

While shared characteristics, like language spoken by the majority of members of a community, have been used to evaluate the quality of found communities, they are not taken as input while determining communities. In this disclosure, items take an explicit input while determining the community structure. In addition, unlike the single attribute characterization of the solution, social network participants in multiple items are taken into account. The notion of like-mindedness for the communities is also formalized.

The importance of such communities from a practical point of view is significant, since the members of a community are both well connected and like minded. Hence, viral marketing strategies are more likely to succeed if initiated on such communities.

Recently, rich data has become available containing information about the social network as well purchase or like/dislike data for the social network participants. Examples may include information about viewers' rating about movies, as well as the friendship relation amongst the viewers. Another example where such data is available is telecom domain where call detail records (CDR) as well as purchase/subscription to value added services (VAS) are available.

It is believed that people's behavior can be linked to the behavior of their social neighborhood. The influence of social neighborhood is demonstrated in the churn behavior of telecom subscribers. People who are interested in an item are usually socially well connected.

Also, people liking (or disliking) an item together are even more socially connected. However, the information about the interests of the people is not used in community finding algorithms.

A community finding problem is defined where the participant of a community also share many interest. Thus, an embodiment herein provides an approach to find such communities. The approach is flexible and is at a meta level. The approach consists of finding tight communities, performing frequent itemset mining to find core members of the like-minded communities and finding the community structures amongst the core community members. Communities found based on the embodiment herein exhibit a stronger tendency to like/dislike items together compared to communities found using only the social interaction data.

Thus, a group of social network participants is defined as a like-minded community if they have the following properties:

1) The group is well connected in the social sense;

2) The group of people share many interests; and

3) The group is maximal, i.e., there is no larger group such that it contains this group and has properties 1 and 2.

Both the conditions 1 and 2 are flexible in that the well connectedness and many interests can be controlled by the user.

Modularity is a fair indicator of social well connectedness, which has also been generalized/modified. In particular, generalized modularity can account for overlapping communities and is equivalent to the conventional definition for non-overlapping communities.

$$Q ( C ) = \frac{1}{2 m} {\sum }_{uv}^{ } ( {A}_{uv} δ ( u , v ) - \frac{{d}_{u} \cdot {d}_{v}}{2 m} \cdot \vert {L}_{u} ⋃ {L}_{v} \vert )$$

where m is the number of undirected edges in the graph (i.e., |E|), Aᵤᵥ is the edge weight of the edge between u and v and dᵤ is the degree of node u. Lᵤ is the set of communities which u is a member of δ(u, v) is 1 if |Lᵤ u Lᵥ|>0, and 0 otherwise.

To formalize the notion of like-mindedness, a new measure captures the level of compatible interests amongst the community members. Let C denote a set of communities on a social network graph G and bipartite rating graph B. Let c ∈ C be a community. Let u and v be two members of community c. The similarity between u and v as the cosine similarity of their ratings is defined, i.e.,:

$$Cos ( u , v ) = \frac{{R}_{u} \cdot {R}_{v}}{‖ {R}_{u} ‖ \cdot ‖ {R}_{v} ‖}$$

where Rᵤ is the rating vector of user u. The numerator is the dot product of the rating vector and the denominator is product of norms of these rating vectors. When the two users do not rate enough items together, the cosine similarity may give a wrong picture. For example, if two people only rate one movie in common and they rate it exactly the same way, assigning them a similarity value of 1 may give a misleading picture. Also, it is not very robust, since a change in only one rating can change the similarity value by a large amount. Cosine similarity is scaled down if there are not enough ratings in common. If the number of movies rated in common by u and v is w<50, then the cosine similarity is scaled by w/50. That is, the weighted cosine similarity between u and v is given as:

$$\begin{matrix}{Cos}_{wt} ( u , v ) = \frac{w}{50} \times \frac{{R}_{u} \cdot {R}_{v}}{‖ {R}_{u} ‖ \cdot ‖ {R}_{v} ‖} if w < 50 \\ = \frac{{R}_{u} \cdot {R}_{v}}{‖ {R}_{u} ‖ \cdot ‖ {R}_{v} ‖} if w \geq 50\end{matrix}$$

However, one can use a rating similarity definition that one prefers, e.g., L₁ or L₂ distance between the ratings if it is suitable for the problem domain.

The like-mindedness of a community structure C is defined as:

$$S ( C ) = \frac{1}{{\sum }_{u , v} δ ( u , v )} {\sum }_{u , v} Sim ( u , v ) \times δ ( u , v )$$

where δ(u, v) is 1 if u and v belong to the same community and 0 if they belong to different communities. This gives a measure of the like mindedness of the people. It is reminiscent of first term in modularity and uses the similarity of the two users in place of edge weight (which may be binary for unweighted graphs). However, unlike modularity, the notion of expected similarity is not required here. Of course, by taking the similarity between u and v as Cos(u, v) and Cos_{wt}(u, v), two version of similarity score for the community set C, which are denoted as S_{cos}(C) and S_{wc}(C), respectively.

The approach to find like-minded communities is now described. One highlight of the approach is that there is a lot of flexibility regarding the choices that need to be made. This approach is at a meta level, wherein suitable definitions, measures and algorithms can be chosen depending on the problem domain and the preferences of the user.

Recall that like-minded communities are socially tight knit groups which share many interests. Let G=(V,E) be the base graph that describes the social interaction. Let B=(V, T,R) be the bipartite graph describing the interests R of people V in items T. Let r denote the compatibility of interests of people in items. If u and v have compatible interest for item i, then this is denoted by (u r, v). |T| graphs are derived from this information for these two graphs in the following manner. For each item tᵢ, a graph G^{r}ᵢ as G^{r}ᵢ=(V^{r}ᵢ, E^{r}ᵢ) is constructed such that e=(u, v) Eᵣ/ᵢ if e ∈ E and (u v). Further, V^{r}ᵢ is the set of vertices v such that e ∈ E^{r}ᵢ and e is incident on v. In other words, for each item, the set of edges is retained from the base graph such that the interests of the nodes on the two sides of the edge are compatible for the chosen compatibility relation.

Primitive communities are found in these graphs G^{r}ᵢ corresponding to each item A set of vertices is divided into primitive communities which are socially tight knit groups typically with more intra community interactions and less inter community interactions. These primitive communities are used as the building block for the like-minded communities.

Now, each maximal primitive community is considered as a transaction with the people as items. The item for which the maximal primitive community is found is attached to the transaction as an additional attribute. Now frequent itemset mining is run on this dataset to find all the closed frequent itemsets. An itemset is called as closed frequent itemset if it has the minimum desired support (i.e., this set of items occurs together in sufficient number of transactions) and there is no itemset which contains this itemset and has equal support. While finding the closed frequent itemsets, distinct items tⱼ are tracked in which this itemset appears together. After finding the closed frequent itemsets, these itemsets are filtered to keep only the itemsets that have number of distinct items tⱼ of compatible interest (besides the required support in conventional sense).

Now, the union of all the closed frequent itemsets is taken, which in turn is a set of people and the induced subgraph of these people is taken. Communities on this graph are found using a community finding method. The communities thus found are the like-minded communities.

Social networks are defined by an induced sub-graph of entities interested in one item at a time to find communities in each graph. The communities are analyzed based on a frequent itemset analysis including two support parameters, the number of communities in which the entities participate together, and the number of distinct shared interests or products. In the frequent itemset algorithm, communities are treated as the transactions and the entities as the items in the transaction. From these support parameters, core communities having core members are found. The core community is then expanded to include as many entities as desired based on a maximum or threshold parameter. The advantage of the current embodiments is that it allows specific communities to be identified which can be monetized based on a sharing of interests. Received data may come in two parts: the social network amongst the participants and the interest of entities in particular items.

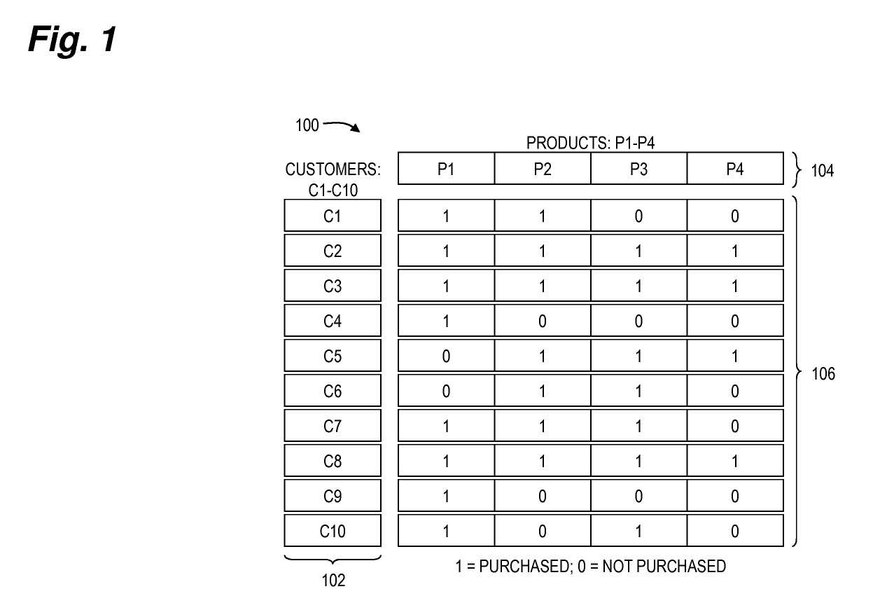

FIG. 1 illustrates a table 100 of product purchase data or an expressed interest in an item for people 102, (customers CI-C10), in a specific number of products 104 (products P1-P4). In section 106 of table 100, a “1” represents that a customer has purchased a product in the associated column, while a “0” represents that a customer has not purchased a product in the associated column.

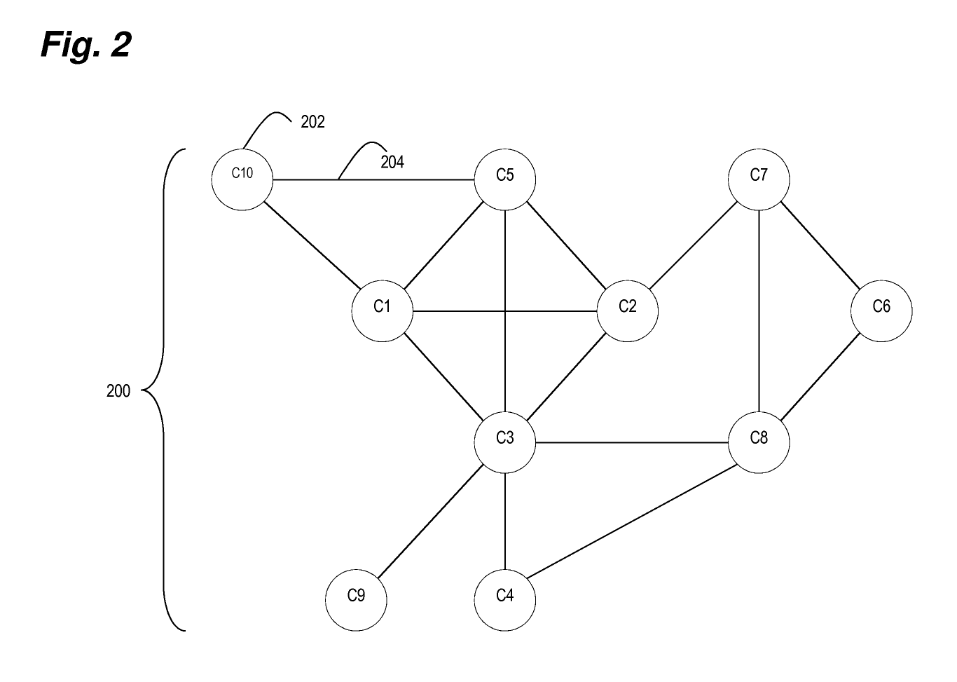

FIG. 2 illustrates an underlying social network 200 of all customers, generally at 202, represented by the circles labeled C1-C10, with lines 204 between customers representing customer associations within the social network. Thus for each customer:

C1 is associated with C2, C3, C5 and C10;

C2 is associated with C1, C3, C5 and C7;

C3 is associated with C1, C2, C4, C5 and C9;

C4 is associated with C3 and C8;

C5 is associated with C1, C2, C3 and C10;

C6 is associated with C7 and C8;

C7 is associated with C2, C6 and C8;

C8 is associated with C3, C4, C6 and C7;

C9 is associated with C3; and

C10 is associated with C1 and C5.

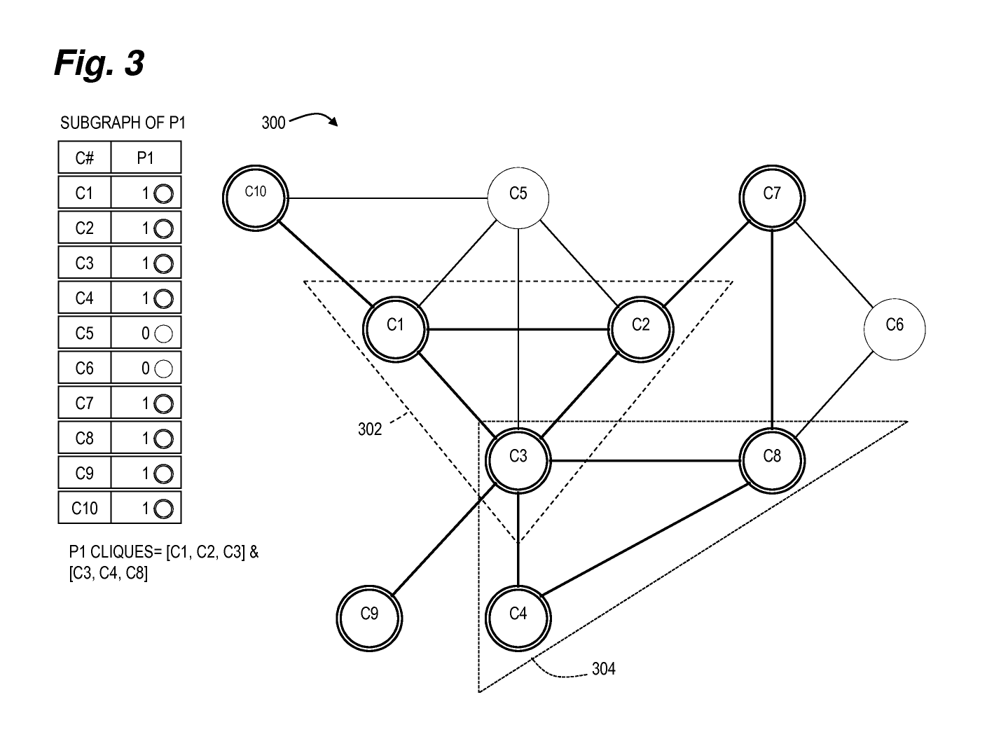

FIGS. 3-6 illustrate a first step of determining for reach respective product (P1, P2, P3 and P4), a primitive community or primitive communities of customers who have purchased the same product and have a particular level of association with other customers in the social network who have purchased the same product(s).

For example, FIG. 3 illustrates a subgraph 300 representing customers C who purchased product P1: C1, C2, C3, C4, C7, C8, C9 and C10. (Each of these customers are represented by a double lined circle and associations between this sub-set of customers are represented by bolded lines.) The embodiment then determines specific primitive communities of customers who purchased product P1 based on the underlying social network. A primitive community is a socially tight knit group typically with more intra community interactions and less inter community interactions.

FIG. 3 illustrates product P1 has a first primitive community, here taken as clique, 302 of customers C1, C2 and C3; and, a second primitive community, here taken as clique, 304 of customers C3, C4 and C8, where each of the nodes in each primitive community, here taken as clique has an edge between respective primitive community nodes.

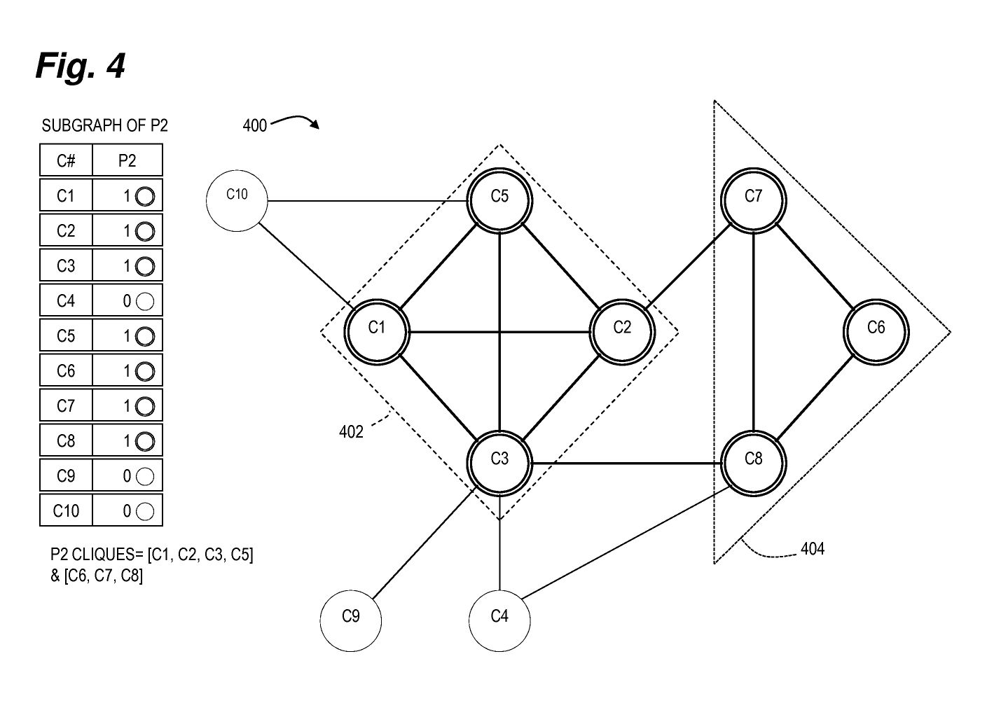

FIG. 4 illustrates the subgraph 400 of product P2 having a first primitive community 402 of customers C1, C2, C3 and C5 and a second primitive community 404 of customers C6, C7 and C8.

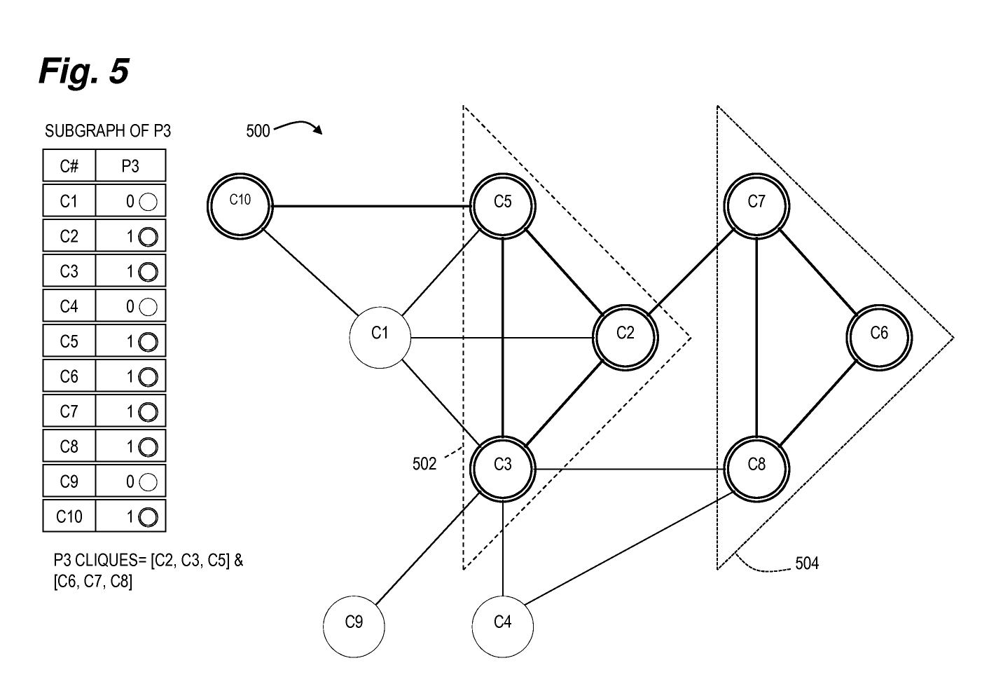

FIG. 5 illustrates the subgraph 500 of product P3, having a first primitive community 502 of customers C2, C3 and C5 and a second primitive community 504 of customers C6, C7 and C8.

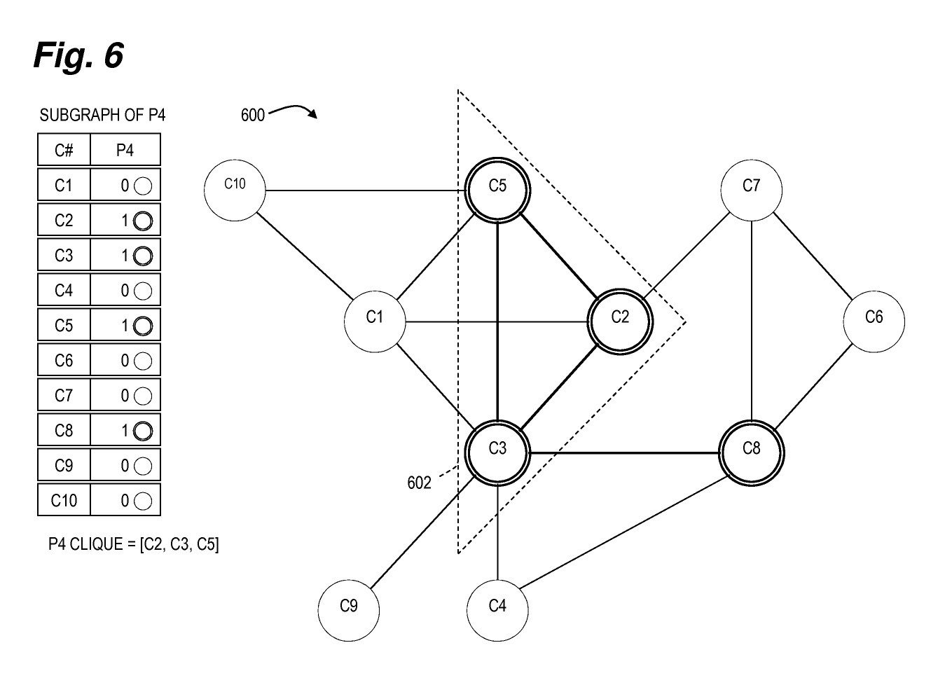

FIG. 6 illustrates the subgraph 600 of product P4, having a single primitive community 602 of customers C2, C3 and C5.

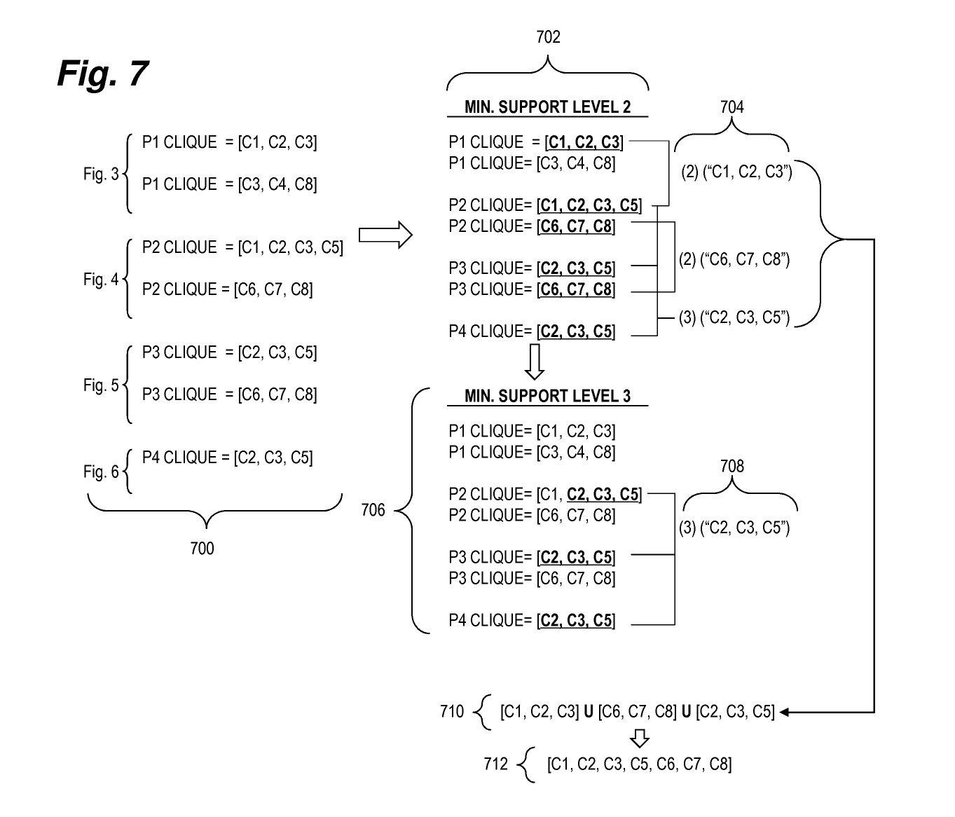

FIG. 7 demonstrates that each of the previously identified primitive communities of FIGS. 3-6 are listed as a row 700 in a Frequent Itemset (FIS) with people (or customers in this example) as items. Frequent itemsets found give sets of people who purchased many products together and who are part of a same social community.

Next, a minimum support level of “2” 702, is determined to identify sets of customers that appear at least twice in the series of identified primitive communities. This minimum support level of “2” yields three sets (704): [C1, C2, C3] from primitive communities of P1 and P2; [C6, C7, C8] from primitive communities of P2 and P3 and [C2,C3,C5] from primitive communities of P2, P3, P4.

Combining all of these identified customers 710 yield customers who have demonstrated similar purchasing behavior related to their socially connected neighbors. The result 712 is customers [C1, C2, C3, C5, C6, C7, C8]. These are the customers who are most likely to be affected by their friend's choice of products.

A minimum support level of “3” 706, identifies sets of customers that appear at least three times in the series of identified primitive communities. This minimum support level of “3” yields only one set (708): [C2, C3, C5] from primitive communities P2, P3 and P4.

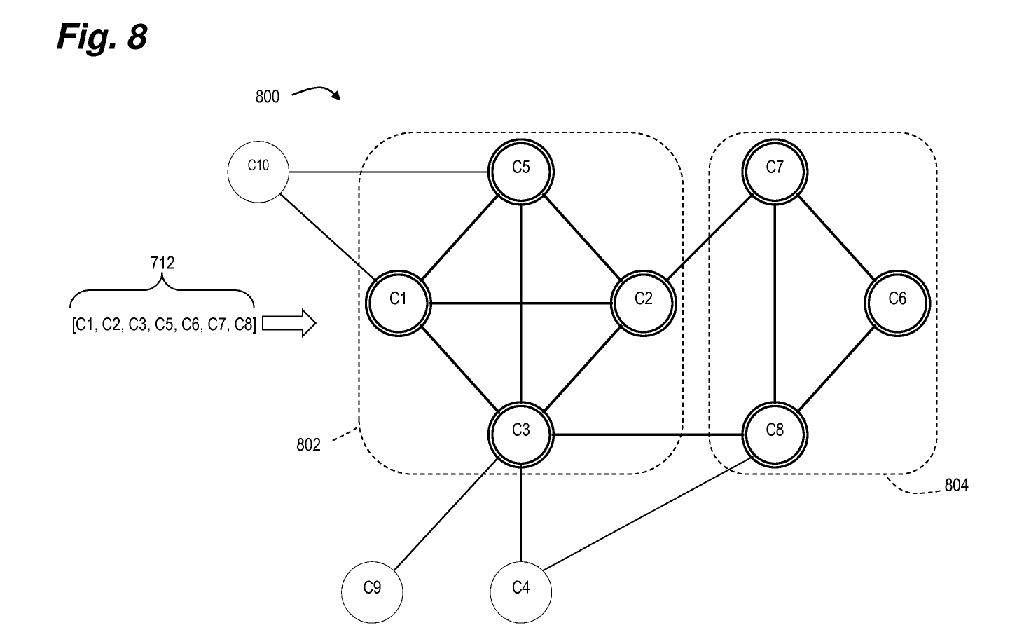

Item 800 in FIG. 8 illustrates that from these customers 712, new social communities, or primitive communities, are determined among these customers based on the underlying social network. Thus, a new community 802 is determined to include customers [C1, C2, C3, C5] and a second new community 804 is determined to include customers [C6, C7, C8].

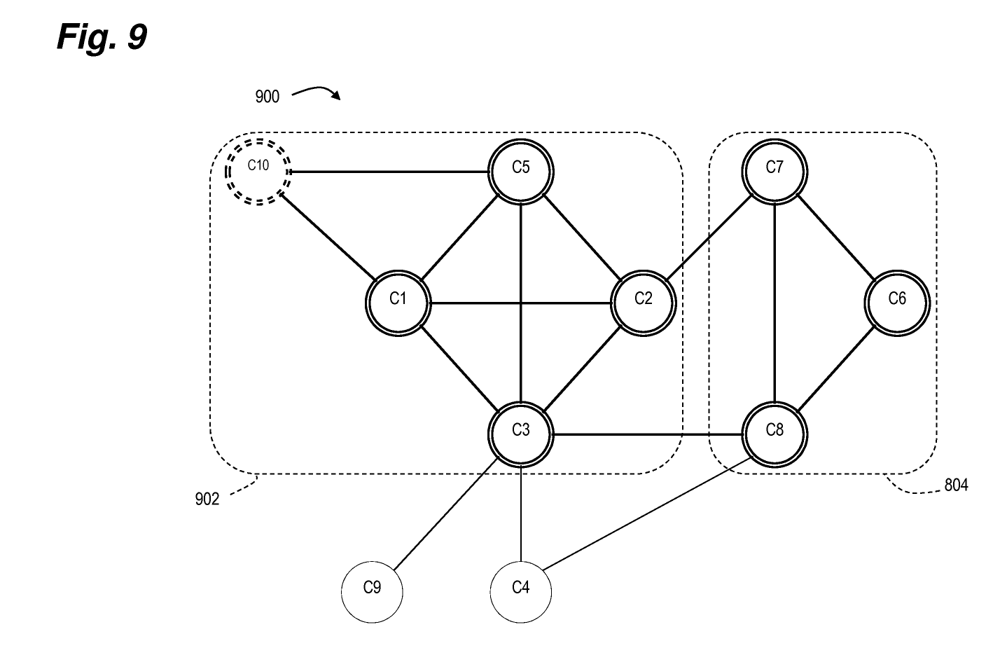

Item 900 in FIG. 9 illustrates that these defined new communities, (e.g., 802 of FIG. 8), may be expanded or grown to include customers who were not a part of the original set by using a strategy of including customers who have a high level of associating to other customers within the new community. E.g., customer C10 is associated with customers C1 and C5 in the new community 802 of FIG. 8. Since both edges of customer C10 are associated with members of the new community, the grown community 902 is expanded to include customer C10 who was originally not associated with the new community 802 of FIG. 8.

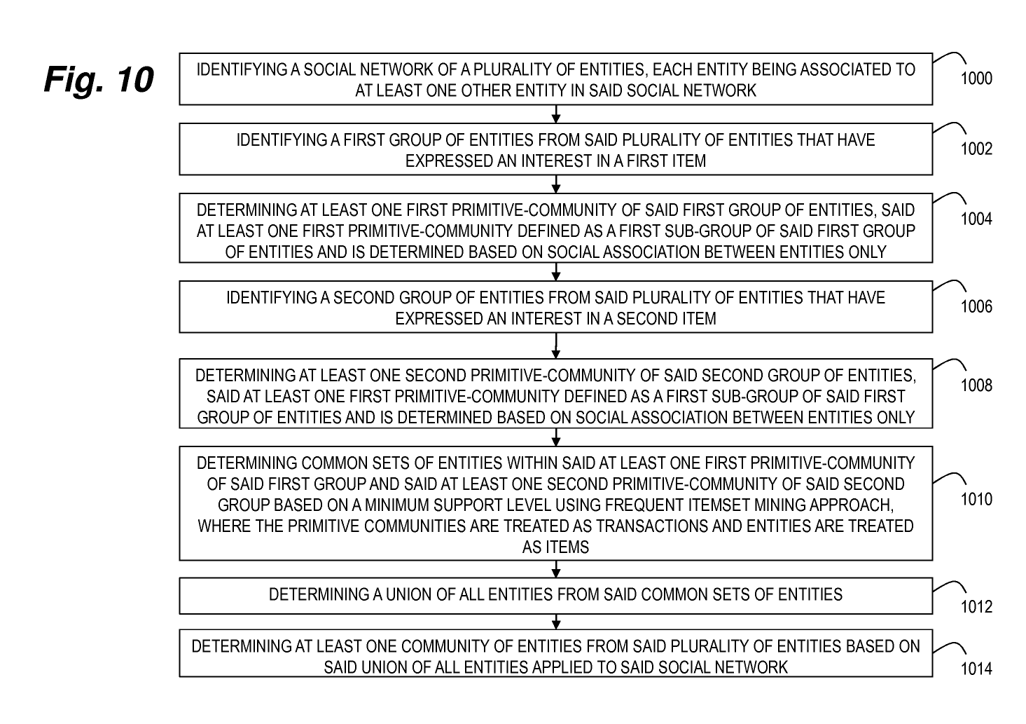

FIG. 10 illustrates a method of identifying a social network of a plurality of entities, where each entity is associated with at least one other entity in the social network 1000. A first group of entities is identified from the plurality of entities that have expressed an interest in a first item 1002. At least one first primitive-community is determined of the first group of entities, the at least one first primitive-community defined as a first sub-group of the first group of entities and is determined based on social association between entities only 1004. A second group of entities is identified from the plurality of entities that have expressed an interest in a second item 1006. At least one second primitive-community is determined of the second group of entities, the at least one first primitive-community defined as a first sub-group of the first group of entities and is determined based on social association between entities only 1008. Common sets of entities are determined within the at least one first primitive-community of the first group and the at least one second primitive-community of the second group based on a minimum support level, using a frequent itemset mining approach, where the primitive communities are treated as transactions and entities are treated as items 1010. A union of all entities is determined from the common sets of entities 1012. At least one community of entities is determined from the plurality of entities based on the union of all entities applied to the social network 1014.

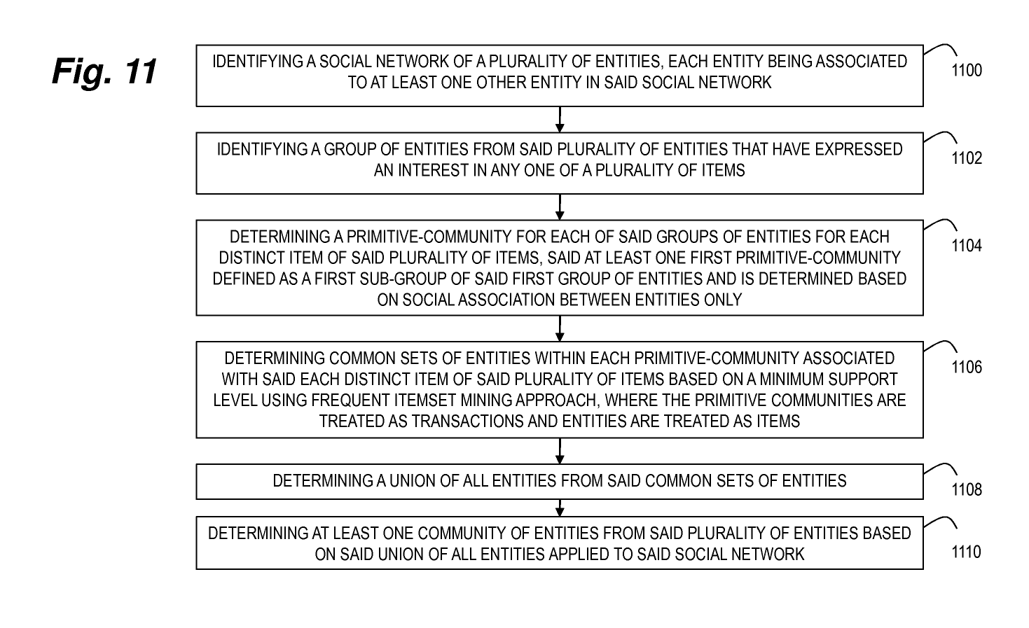

FIG. 11 illustrates a method of identifying a social network of a plurality of entities, each entity being associated with at least one other entity in the social network 1100. Identifying a group of entities from the plurality of entities that have expressed an interest in any one of a plurality of items 1102. A primitive-community is determined for each of the groups of entities for each distinct item of the plurality of items, the at least one first primitive-community defined as a first sub-group of the first group of entities and is determined based on social association between entities only 1104. Common sets of entities are determined within each primitive-community associated with the each distinct item of the plurality of items based on a minimum support level, using a frequent itemset mining approach, where the primitive communities are treated as transactions and entities are treated as items 1106. A union of all entities is determined from the common sets of entities 1108. At least one community of entities is determined from the plurality of entities based on the union of all entities applied to the social network 1110.

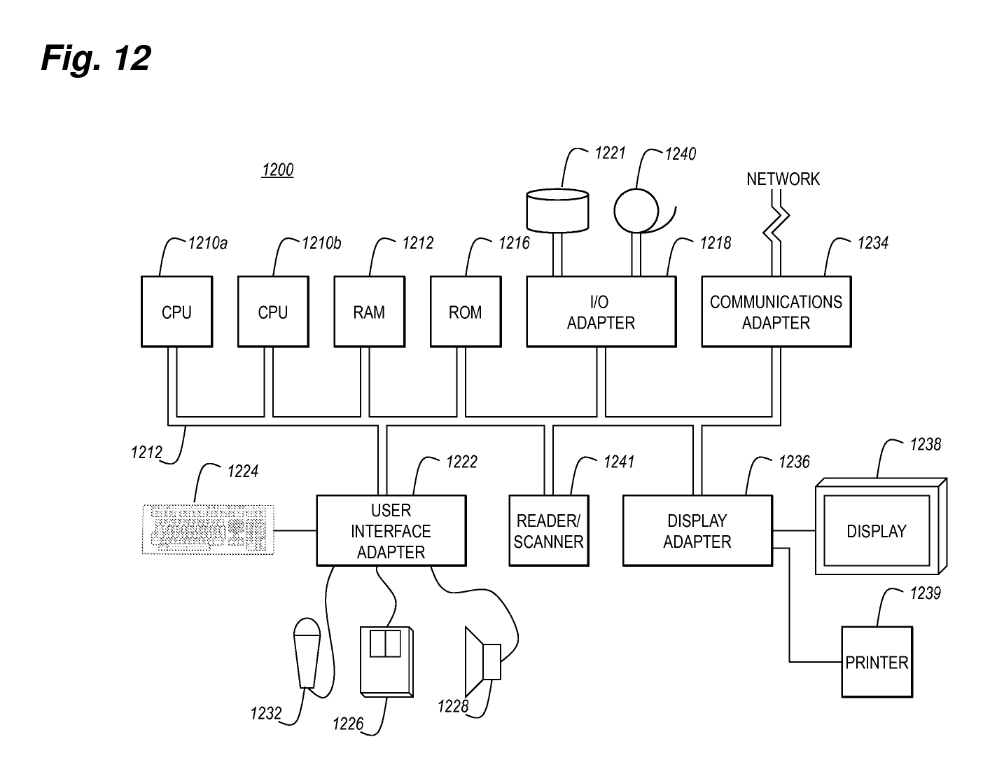

With reference to FIG. 12, a computer system 1200 used to implement an embodiment is illustrated showing aspects that may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects herein may take the form of a computer program product embodied in at least one computer readable medium(s) having computer readable program code embodied thereon.

Any combination of at least one computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having at least one wire, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects may be written in any combination of at least one programming language, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects herein are described below with reference to flowchart illustrations and/or block diagrams of methods, apparatus (systems) and computer program products according to embodiments herein. It will be understood that each block of the flowchart illustrations and/or D-2 block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

A representative hardware environment for practicing the embodiments herein is depicted in FIG. 12. This schematic drawing illustrates a hardware configuration of an information handling/computer system in accordance with the embodiments herein. The system comprises at least one processor or central processing units (CPU) 1210a, 1210b. The CPUs 1210a, 1210b are interconnected via system bus 1212 to various devices such as a random access memory (RAM) 1214, read-only memory (ROM) 1216, and an input/output (I/O) adapter 1218. The I/O adapter 1218 can connect to peripheral devices, such as disk units 1221 and tape drives 1240, or other program storage devices that are readable by the system. The system can read the inventive instructions on the program storage devices and follow these instructions to execute the methodology of the embodiments herein. The system further includes a user interface adapter 1222 that connects a keyboard 1224, mouse 1226, speaker 1228, microphone 1232, and/or other user interface devices such as a touch screen device (not shown) to the bus 1212 to gather user input. The system further includes a reader/scanner 1241 device that connects to the bus 1212. Additionally, a communication adapter 1234 connects the bus 1212 to a data processing network, and a display adapter 1236 connects the bus 1212 to a display device 1238 which may be embodied as an output device such as a monitor, printer 1239, or transmitter, for example.

The flowchart and block diagrams in FIG. 12 illustrate the architecture, functionality, and operation of possible implementations of systems, methods and computer program products according to various embodiments of the herein. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The terminology used herein is for the purpose of describing particular embodiments only and is not intended to be limiting herein. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of other features, integers, steps, operations, elements, components, and/or groups thereof. The corresponding structures, materials, acts, and equivalents of all means or step plus function elements in the claims below are intended to include any structure, material, or act for performing the function in combination with other claimed elements as specifically claimed. The description of the herein has been presented for purposes of illustration and description, but is not intended to be exhaustive or limited to the invention in the form disclosed. Many modifications and variations will be apparent to those of ordinary skill in the art without departing from the scope and spirit herein. The embodiment was chosen and described in order to best explain the principles herein and the practical application, and to enable others of ordinary skill in the art to understand the invention for various embodiments with various modifications as are suited to the particular use contemplated.

1-20. (canceled)

21. A non-transitory computer storage medium readable by a computer tangibly embodying a program of instructions executable by said computer for performing a method comprising:
identifying a social network of a plurality of entities, each entity being associated to at least one other entity in said social network;
identifying a first group of entities from said plurality of entities that have expressed an interest in a first item;
determining at least one first primitive-community of said first group of entities, said at least one first primitive-community being defined as a first sub-group of said first group of entities and being determined based only on social association between entities;
identifying a second group of entities from said plurality of entities that have expressed an interest in a second item;
determining at least one second primitive-community of said second group of entities, said at least one first primitive-community being defined as a first sub-group of said first group of entities and being determined based only on social association between entities;
determining common sets of entities within said at least one first primitive-community of said first group and said at least one second primitive-community of said second group based on a minimum support level, using a frequent itemset mining approach, where said first primitive community and said second primitive community are treated as transactions and said entities are treated as items in said frequent itemset mining approach;
determining a union including all distinct entities from said common sets of entities; and
determining at least one community of entities from said social network plurality of entities based on said union of all entities applied to said social network.

22. The non-transitory computer storage medium according to claim 21, said interest in said first item and said interest in said second item further comprising customer purchase data.

23. The non-transitory computer storage medium according to claim 21, said first item comprising a first single item, and said second item comprising a second single item.

24. The non-transitory computer storage medium according to claim 21, said first item being distinct from said second item.

25. The non-transitory computer storage medium according to claim 21, where said entities of said plurality of entities comprising one of animals, people, organizations, business entities and artificial intelligence entities.

26. A non-transitory computer storage medium readable by a computer tangibly embodying a program of instructions executable by said computer for performing a computer-implemented method comprising:
identifying a social network of a plurality of entities;
identifying a first group of entities from said plurality of entities that have expressed an interest in a first item;
determining first social associations within said first group of entities and grouping said first group of entities into first primitive-communities based only on said first social associations;
identifying a second group of entities from said plurality of entities that have expressed an interest in a second item;
determining second social associations within said second group of entities and grouping said second group of entities into second primitive-communities based only on said second social associations;
determining which of said first primitive communities are also present in said at least one of said second primitive communities to identify common sets of entities; and
outputting at least one community of entities comprising all entities within said common sets of entities.

27. The non-transitory computer storage medium according to claim 26, said interest in said first item and said interest in said second item further comprising customer purchase data.

28. The non-transitory computer storage medium according to claim 26, said first item comprising a first single item, and said second item comprising a second single item.

29. The non-transitory computer storage medium according to claim 26, said first item being distinct from said second item.

30. The non-transitory computer storage medium according to claim 26, said determining of which of said first primitive communities are also present in said at least one of said second primitive communities being based on a minimum support level equal to a value of a number of times a particular common set of entities is found for each primitive-community.

31. The non-transitory computer storage medium according to claim 30, said value being equal to two.

32. The non-transitory computer storage medium according to claim 26, said plurality of entities comprising one of animals, people and organizations.

33. The non-transitory computer storage medium according to claim 26, said plurality of entities comprising one of business entities and artificial intelligence entities.

34. A non-transitory computer storage medium readable by a computer tangibly embodying a program of instructions executable by said computer for performing a computer-implemented method comprising:
identifying a social network of a plurality of entities, each entity being associated to at least one other entity in said social network;
identifying a group of entities from said plurality of entities each having associated data representing an interest in one of a plurality of items;
determining a primitive-community for each of said groups of entities for each distinct item of said plurality of items, said at least one first primitive-community being defined as a first sub-group of said first group of entities and being determined based only on social association between entities;
determining common sets of entities within each primitive-community associated with said each distinct item of said plurality of items based on a minimum support level, using a frequent itemset mining approach, where said first primitive community and said second primitive community are treated as transactions and said entities are treated as items in said frequent itemset mining approach;
determining a union including all distinct entities from said common sets of entities; and
determining at least one community of entities from said social network plurality of entities based on said union of all entities applied to said social network.

35. The non-transitory computer storage medium according to claim 34, said interest in said one of said plurality of items further comprises customer purchase data.

36. The non-transitory computer storage medium according to claim 34, each of said plurality of items comprising a single item.

37. The non-transitory computer storage medium according to claim 34, each of said plurality of items being distinct from all other of said plurality of items.

38. The non-transitory computer storage medium according to claim 34, where said entities of said plurality of entities comprising one of animals, people, organizations, business entities and artificial intelligence entities.
